(19) United States
(12) Patent Application Publication
(10) Pub. No.: US 2025/0156404 A1
(43) Pub. Date: May 15, 2025

(54) ENHANCED METHODOLOGY FOR OPTIMIZING DATA QUERY PROMPTS

(71) Applicant: HITACHI, Ltd., Tokyo (JP)

(72) Inventors: Takuya HABARA, Santa Clara, CA (US); Shoji YUNOKI, Santa Clara, CA (US); Sudhanshu GAUR, Cupertino, CA (US)

(21) Appl. No.: 18/388,249

(22) Filed: Nov. 9, 2023

(51) Int. Cl. G06F 16/242; G06F 16/21; G06F 16/25

(52) U.S. Cl. CPC G06F 16/242; G06F 16/212; G06F 16/254

(57) ABSTRACT

A search query generation method for information retrieval, the method comprising receiving, by a processor, a first query issued by a user; extracting, by the processor, a plurality of field status items associated with the first query; extracting, by the processor, first schema information associated with the plurality of field status items; adding, by the processor, the plurality of field status items and the first schema information as contextual information to the first query to generate a second query, generating, by the processor, an information search code based on the second query; and executing, by the processor, the information search code to retrieve information associated with the first query from a plurality of data source systems.

### BACKGROUND

### Field

The present disclosure is generally directed to a method and a system for information retrieval.

### Related Art

Many businesses today are engaged in digital transformation, which aims to improve operational efficiency and add value with digital technology. Digital transformation involves connecting different systems and sharing data between the systems. For example, data can be shared and exchanged by connecting business-related systems including enterprise resource planning (ERP) systems, product lifecycle management (PLM) systems, manufacturing execution systems (MES), etc. Data from connected systems can be shared on an information sharing platform. In addition, data related to the digital transformation project itself is distributed across file servers, team collaboration tools, code sharing platforms, etc. Unified data access is therefore made possible on the information sharing platform.

Various data including, but not limited to, documents, program codes, numerical data, images, sounds, etc., can be stored on the information sharing platform. A good search system is necessary for users to find the desired data from the large amount of available data on the information sharing platform. For example, if the user wants to retrieve information from a relational database, the user uses a structured query language to perform a precise search. If the user wants to retrieve information from documents in a file system, the user can perform a full-text search using keywords. When searching data in an information sharing platform, where information from different systems is aggregated, it is necessary to be able to search information without being aware of the differences between the systems.

In the related art, a method utilizing artificial intelligence (AI) in performing data retrieval is disclosed. Various users including business owners, system architects, field workers, data analysts, maintenance technicians, robots, etc., can easily retrieve the necessary information by querying to AI in natural language. In addition, AI has the advantage of searching not just only for a single document, but also generating sentences that summarize multiple pieces of data and presenting them to the user, or displaying a list of related documents produced as search results.

However, appropriate queries are necessary in order to retrieve the desired user information. If a query is ambiguous, then unrelated/unwanted information may be retrieved instead, which results in time wasted in processing additional queries to reach the desired information. On the other hand, creating a specific query requires business knowledge about the data stored in the information sharing platform, such as understanding the types of data being stored, which places a heavy burden on the user in query generation.

In the related art, a method for performing fact/rule generation for a given search target is disclosed. Searched information by these expansions will only generate static results to the user, and unable to keep up with current changes in real-time.

In the related art, a system that leverages semantic searching for determining similar prompts for use in retraining is disclosed. A prompt can be generated and searched to identify similar prompts. Data related to the identified similar prompts can then be utilized for prompt tuning. While the system improves retrieval capability by prompt training, however, it is unable to keep up with current changes given that it is unable to track direct changes in real-time.

There exists a need for a system that is capable of generating specific queries that include business knowledge without increasing the burden on the users.

### SUMMARY

Aspects of the present disclosure involve an innovative method for performing information retrieval. The method may include receiving, by a processor, a first query issued by a user; extracting, by the processor, a plurality of field status items associated with the first query; extracting, by the processor, first schema information associated with the plurality of field status items; adding, by the processor, the plurality of field status items and the first schema information as contextual information to the first query to generate a second query; generating, by the processor, an information search code based on the second query; and executing, by the processor, the information search code to retrieve information associated with the first query from a plurality of data source systems.

Aspects of the present disclosure involve an innovative non-transitory computer readable medium, storing instructions for performing information retrieval. The instructions may include receiving a first query issued by a user; extracting a plurality of field status items associated with the first query; extracting first schema information associated with the plurality of field status items; adding the plurality of field status items and the first schema information as contextual information to the first query to generate a second query; generating an information search code based on the second query; and executing the information search code to retrieve information associated with the first query from a plurality of data source systems.

Aspects of the present disclosure involve an innovative server system for performing information retrieval. The system may include receiving, by a processor, a first query issued by a user; extracting, by the processor, a plurality of field status items associated with the first query; extracting, by the processor, first schema information associated with the plurality of field status items; adding, by the processor, the plurality of field status items and the first schema information as contextual information to the first query to generate a second query; generating, by the processor, an information search code based on the second query; and executing, by the processor, the information search code to retrieve information associated with the first query from a plurality of data source systems.

Aspects of the present disclosure involve an innovative system for performing information retrieval. The system may include means for receiving a first query issued by a user; means for extracting a plurality of field status items associated with the first query; means for extracting first schema information associated with the plurality of field status items; means for adding the plurality of field status items and the first schema information as contextual information to the first query to generate a second query; means for generating an information search code based on the second query; and means for executing the information search code to retrieve information associated with the first query from a plurality of data source systems.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example information search query generation system 100, in accordance with an example implementation.

FIG. 2 illustrates an example assembly plant information system 200 implementing the information search query generation system 100 of FIG. 1, in accordance to an example implementation.

FIG. 3 illustrates an example query generation process flow 300, in accordance with an example implementation.

FIG. 4 illustrates an example field situation table 104, in accordance to an example implementation.

FIG. 5 illustrates example field situation items 500 extracted by the situation addition unit 110, in accordance with an example implementation.

FIG. 6 illustrates an example schema table 105, in accordance with an example implementation.

FIG. 7 illustrates example schema information 700 extracted by the schema addition unit 111, in accordance with an example implementation.

FIG. 8 illustrates example field situation items 800 extracted by the situation addition unit 110 in association with the second use case, in accordance with an example implementation.

FIG. 9 illustrates example schema information 900 extracted by the schema addition unit 111 as applied in the second use case, in accordance with an example implementation.

FIG. 10 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Present example implementations relate to methods and systems for performing query generation that takes business knowledge into account while reducing the query input burden on the users. Example implementations extract the information a user is searching for without increasing the burden on the user by adding contextual information that follows the current situation to the user's query. The contextual information may include, but not limited to, information associated with the organization and work of the user, the time and place where the query is input, scheduled and actual work performed on site, the method of communication with data sources, the types of data being stored, etc.

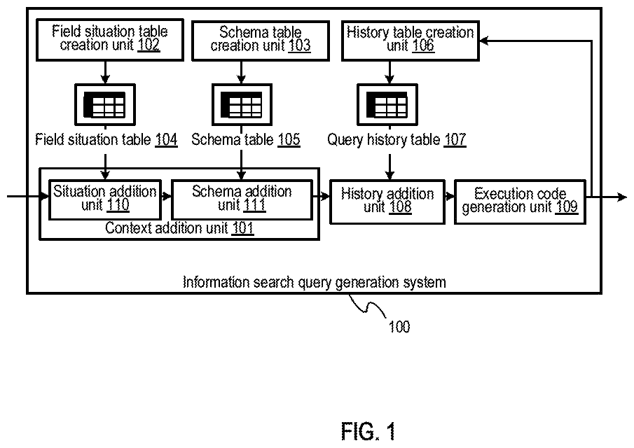

A first use case involves query input involving workers performing assembly work in an assembly plant. FIG. 1 illustrates an example information search query generation system 100, in accordance with an example implementation. The information search query generation system 100 may include components such as, but not limited to, a context addition unit 101, a field situation table creation unit 102, a schema table creation unit 103, a field situation table 104, a schema table 105, a history table creation unit 106, a query history table 107, a history addition unit 108, and an execution code generation unit 109.

The context addition unit 101 analyzes a query input/entered by a user and extracts field situation items and associated schema information based on the query. The context addition unit 101 further adds the field situation items and the schema information as contextual information to the query to generate a second query. As illustrated in FIG. 1, the context addition unit 101 may include components such as a situation addition unit 110 and a schema addition unit 111. The situation addition unit 110 performs extraction of the field situation information/items related to the query entered by the user from the field situation table 104, and the schema addition unit 111 performs extraction of the schema information related to the extracted field situation items from the schema table 105.

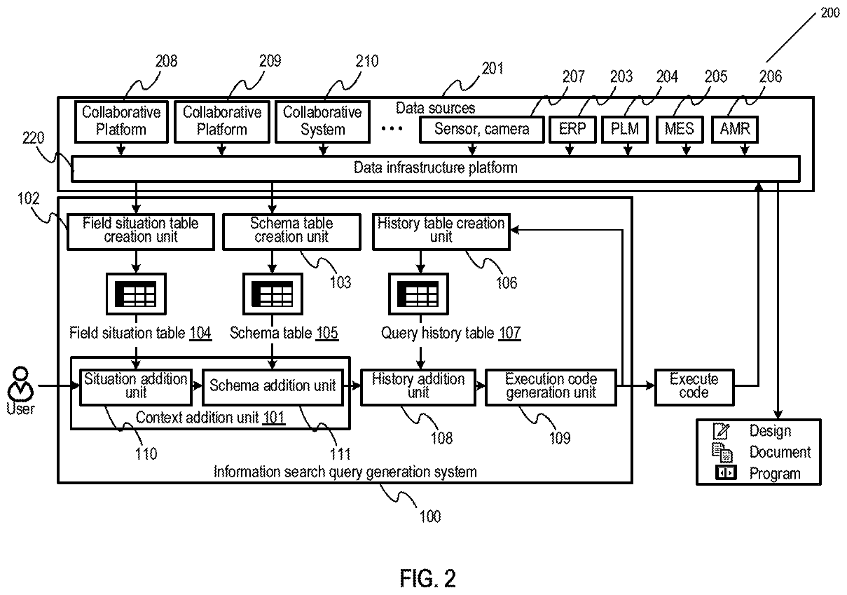

The field situation table 104 contains shop floor situation information of the assembly plant, and is generated and updated by the field situation table creation unit 102. In some example implementations, the shop floor situation information may include information associated with business resources, product lifecycle, manufacturing execution, etc. The field situation table 104 will be described in more detail below under FIG. 2.

The schema table 105 contains information necessary to obtain the shop floor situation information of field situation table 104, and is generated and updated by the schema table creation unit 103. The schema table 105 may include information such as, but not limited to, data format, database address, authentication information, table name, data type, directory name, etc. The schema table 105 will be described in more detail below under FIG. 2.

The query history table 107 stores information pertaining to queries that have been executed in the past, and is generated and updated by the history table creation unit 106. The query history table 107 may contain information such as, but not limited to, the date and time of the executed query, user-entered queries, revised queries with added contextual information from the field situation table 104 and the schema table 105, information-seeking execution code, etc. The query history table 107 will be described in more detail below under FIG. 2.

The history addition unit 108 searches the query history table 107 and extracts past queries that are similar to the second query generated by the context addition unit 101. Past query information associated with the extracted past queries are then added to the second query by the history addition unit 108. The execution code generation unit 109 generates an information search execution code based on the second query. The information search execution code is executed to retrieve information as required by the user from various data sources based on the input query.

FIG. 2 illustrates an example assembly plant information system 200 implementing the information search query generation system 100 of FIG. 1, in accordance to an example implementation. In some example implementations, the assembly plant information system 200 may include components such as, but not limited to, the information search query generation system 100, data source system 201, etc.

The data source system 201 may include systems such as, but not limited to, enterprise resource planning (ERP) system 203, product lifecycle management (PLM) system 204, manufacturing execution systems (MES) 205, autonomous mobile robot (AMR) 206, monitoring sensors/cameras/devices 207, etc. In some example implementations, data source systems 201 may include collaborative platforms/systems 208-210 such as messaging applications, program code revision control systems, internet sites pages, document libraries, etc. The data source system 201 further includes a data infrastructure platform 220, which provides common access methods and data flow control to achieve collaboration among the various data sources in the data source system 201. When the information search execution code generated by execute execution code generation unit 109 is executed, information (e.g. data, table, file, etc.) and/or program may retrieved from the various data sources through the data infrastructure platform 220.

The ERP system 203 stores business resource information including, but not limited to, worker information, order information, and work order information. The worker information includes the employee/worker's name, position, job, duration of their work, etc. The order information includes the client, delivery due date, product name, quantity, inventory information, etc. The work order information includes recorded plans for products and number of units of products to be produced on a daily, weekly, or monthly basis.

The PLM system 204 stores the product lifecycle information including, but not limited to, product specification information, production method of the product information, etc. The product specification information includes product blueprints, lists of parts required for assembly, etc. The production method of the product information includes assembly manuals, inspection manuals, etc.

The MES 205 stores manufacturing execution information that comprises detailed work plan information, which includes plans for what and how many units are to be produced on a predetermined time unit, the worker/employee responsible for tasks such as assembly and inspection, locations where assembly and inspection are to be performed, etc. The detailed work plan information can be dynamically changed based to the situation on the shop floor. The MES 205 also stores work execution status information, which includes the completion time of each product produced or inspection process, the name of the worker in charge, the work execution location, etc. As with the detailed work plan information, the status of work execution information can be dynamically changed according to on-site situations. In some example implementations, the work execution status information may be entered by workers using input devices such as, but not limited to, laptop, kiosks, tablets, mobile devices, devices using radio-frequency identification, devices utilizing two-dimensional matrix barcode, devices using camera images or microphone sound installed in the factory, etc.

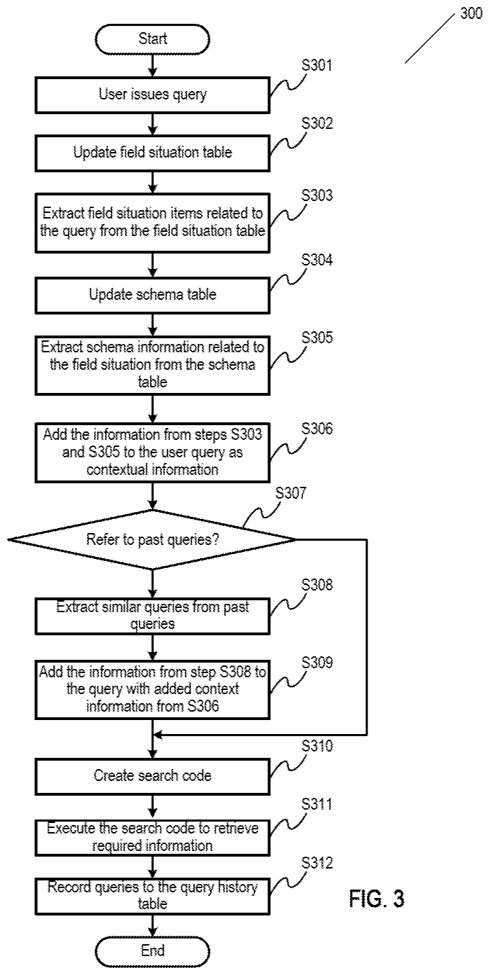

FIG. 3 illustrates an example query generation process flow 300, in accordance with an example implementation. The process begins at step S301 where the user issues enters query, which is received the by information search query generation system 100. For example, a user by the name Clara enters the query “show me the manual” in cell-A at 8:50 AM on Jul. 10, 2023. At step S302, the field situation table creation unit 102 performs updating of the field situation table 104.

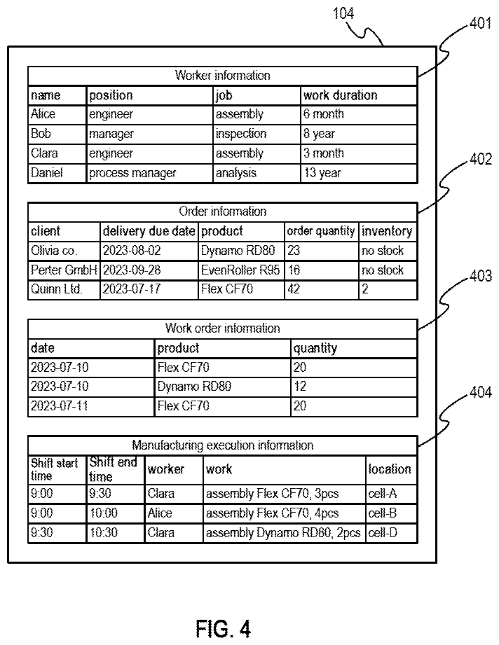

FIG. 4 illustrates an example field situation table 104, in accordance to an example implementation. As illustrated in FIG. 4, the field situation table 104 may include information such as, but not limited to, worker information 401, order information 402, work order information 403, manufacturing execution information 404, etc. The information stored in the field situation table 104 is obtained from the various data sources such as ERP systems, PLM systems, MES, etc. In some example implementations, information stored in the field situation table 104 may be saved in a non-tabular format such as comma-separated values (CSV), extensible markup language (XML), JavaScript object notation (JSON), etc.

The worker information 401 may include fields such as name, position, job, work duration, etc. The order information 402 may include fields such as client name/identifier, delivery due date, product name/identifier, order quantity, inventory, etc. The work order information 403 may include fields such as date, product name/identifier, quantity produced, etc. The manufacturing execution information 404 may include fields such as shift start time, shift end time, worker name/identifier, product and quantity, location, etc.

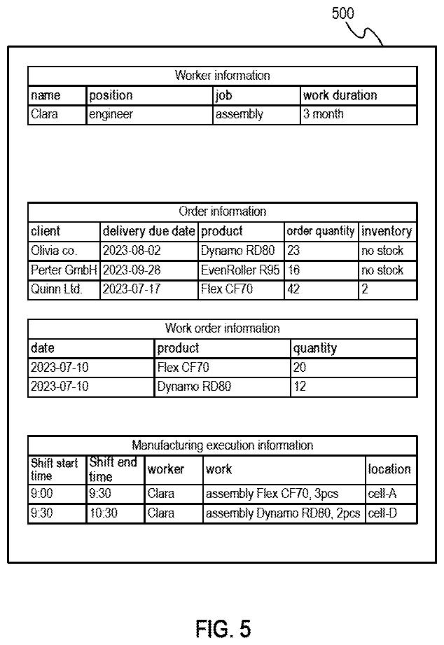

Referring back to FIG. 3, at step S303, the situation addition unit 110 extracts field situation items related to the input query in real-time. As illustrated in FIG. 4, since the query was issued by a user by the name Clara, information pertaining to Clara is extracted from worker information 401. For order information 402, the complete information is extracted since information is unable to be narrowed based on the input query. For work order information 403, since the query was issued on Jul. 10, 2023, work order information pertaining to the date of Jul. 10, 2023 is extracted. For manufacturing execution information 404, since the query was issued by Clara, manufacturing execution information related to work performed by Clara is extracted. FIG. 5 illustrates example field situation items 500 extracted by the situation addition unit 110, in accordance with an example implementation. A trained artificial intelligence (AI) model may be used in extracting the field situation items. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc.

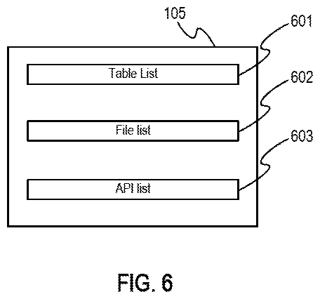

At step S304, the schema table creation unit 103 updates the schema table 105. FIG. 6 illustrates an example schema table 105, in accordance with an example implementation. The schema table 105 includes information such as, but not limited to, a table list 601, a file list 602, an application program interface (API) list 603, etc. The table list 601 contains schema information related to data recorded in tabular format among the data to be handled by the information search query generation system 100. Specifically, the table list 601 may include information such as, but is not limited to, an overview of recorded data, access methods to the database such as authentication information, structure of tables, etc.

The file list 602 contains schema information related to data recorded in file format among the data to be handled by the information search query generation system 100. Specifically, the file list 602 may include information such as, but is not limited to, file names and summaries of recorded files, authentication information, paths, other file access methods, etc.

The API list 603 contains schema information related to data that can be accessed by application programming interface (API) among the data handled by the information search query generation system 100. Specifically, API list 603 may include information such as, but not limited to, the name and summary of the data to be accessed, authentication information, paths, other data access methods, etc.

In some example implementations, schema information about data recorded in tabular format and file format may also be included in the API list 603. The information contained in the schema table 105 may be recorded in tabular format, CSV, XML, JSON, or other formats. If the information recorded in the schema table 105 is out of date and inappropriate for query generation, then the schema table 105 is updated with real-time information.

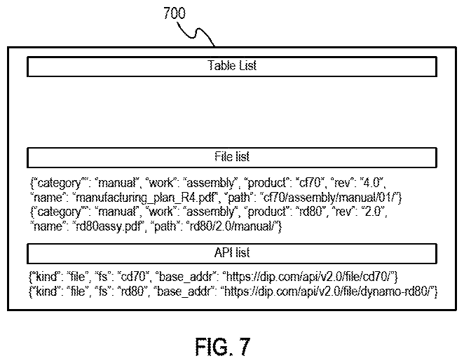

The process then continues to step S305 where the schema addition unit 111 extracts schema information related to the field situation items extracted during step S303 in real-time. FIG. 7 illustrates example schema information 700 extracted by the schema addition unit 111, in accordance with an example implementation. A trained artificial intelligence (AI) model may be used in extracting the schema information. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc.

At step S306, the context addition unit 101 adds the extracted field situation items and the extracted schema information as contextual information to the input query to generate a second query. At step S307, a determination is made as to whether past queries are to be referred. In some example implementations, the decision on whether to refer to past queries is made by the user. In some example implementations, the operator of the information search query generation system 100 may set a default value in advance, or the decision may be made by looking at contents of the second query generated in step S306. If the answer is no at step S307, then the process continues to step S310, which will be described in more detail below.

If the answer is yes at step S307, then the process continues to step S308 where the history addition unit 108 searches the query history table 107 and extracts queries that are similar to the second query generated in step S306. In some example implementations, a trained artificial intelligence (AI) model may be used in the exaction of past queries. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc. At step S309, the history addition unit 108 identifies and adds past query information associated with the past queries extracted in step S308 to the second query, and the process proceeds to step S310. In the first use case, past query information related to assembly work instructions is identified and added to the second query.

At step S310, the execution code generation unit 109 generates an information search execution code based on the second query generated at step S306 or S309. An artificial intelligence (AD) model may be used in generating the information search code. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc. The field situation information extracted in step S303 indicates that the user is searching for an assembly manual for “Flex CF70”. The schema information extracted in step S305 indicates that the manual is stored in the path “cf70/assembly/manual/01/” and can be accessed by issuing an API base path (using HTTPS protocol) of “dip.com/api/v2.0/file/cd70/”. Through use of the AI model, the execution code generation unit 109 then generates the information retrieval code of “GET: dip.com/api/v2.0/file/cd70/assembly/manual/01/manufacturing_plan_R4.pdf”.

At step S311, the information search code generated is executed to retrieve information required by the user from the various data sources. Finally, at step S312, the history table creation unit 106 updates the query history table 107 with the input query, the time of query input, the second query of step S306 or S309, and the information search code associated as past query.

A second use case is described below and involves query input involving workers performing process management work in an assembly plant. The process flow 300 of FIG. 3 is used to explain the query generation process of the second use case below.

The process begins at step S301 where a query is issued/input by the user. In the second use case, a user, an employee of working at the assembly plant, by the name Daniel, issues the query “want to know the downtime” in cell-A at 1:00 PM on Jul. 10, 2023. At step S302, the field situation table creation unit 102 updates the field situation table 104.

At step S303, the situation addition unit 110 extracts field situation items related to the query issued in step S301 in real-time. Since the query was issued by a user by the name Daniel, information pertaining to Daniel is extracted from worker information 401. For order information 402, the complete information is extracted since information is unable to be narrowed based on the input query. For work order information 403, since the query was issued on Jul. 10, 2023, work order information pertaining to the date of Jul. 10, 2023 is extracted. For manufacturing execution information 404, since there is no item directly related to Daniel who issued the query, the complete manufacturing execution information is extracted.

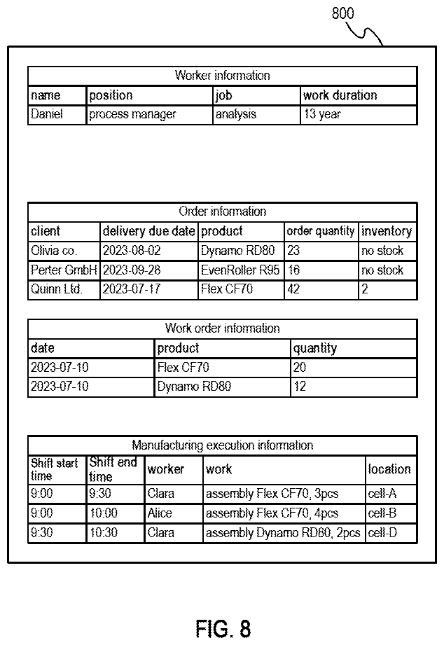

FIG. 8 illustrates example field situation items 800 extracted by the situation addition unit 110 in association with the second use case, in accordance with an example implementation. An artificial intelligence (AI) model may be used in extracting the field situation items. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc.

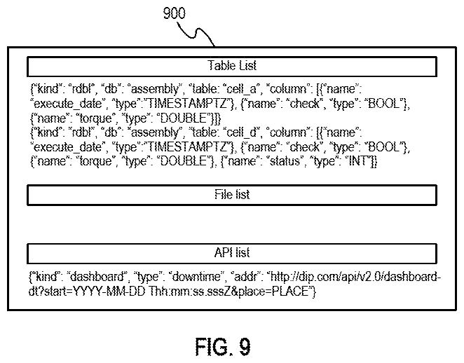

At step S304, the schema table creation unit 103 updates the schema table 105. Similar to FIGS. 6 and 7, the schema table 105 includes information such as, but not limited to, a table list 801, a file list 802, an application program interface (API) list 803, etc. The process then continues to step S305 where the schema addition unit 111 extracts schema information related to the field situation items extracted during step S303 in real-time. FIG. 9 illustrates example schema information 900 extracted by the schema addition unit 111 as applied in the second use case, in accordance with an example implementation. An artificial intelligence (AI) model may be used in extracting the schema information. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc.

At step S306, the context addition unit 101 adds the extracted field situation items and the extracted schema information as contextual information to the input query to generate a second query. At step S307, a determination is made as to whether past queries are to be referred. In some example implementations, the decision on whether to refer to past queries is made by the user. In some example implementations, the operator of the information search query generation system 100 may set a default value in advance, or the decision may be made by looking at contents of the second query generated in step S306. If the answer is no at step S307, then the process continues to step S310.

If the answer is yes at step S307, then the process continues to step S308 where the history addition unit 108 searches the query history table 107 and extracts queries that are similar to the second query generated in step S306. In some example implementations, an artificial intelligence (AI) model may be used in the exaction of past queries. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc. At step S309, the history addition unit 108 identifies and adds past query information associated with the past queries extracted in step S308 to the second query, and the process proceeds to step S310. In the second use case, past query information related to downtime is identified and added to the second query.

At step S310, the execution code generation unit 109 generates an information search execution code based on the second query generated at step S306 or S309. In some example implementations, an artificial intelligence (AI) model may be used in generating the information search code. Such AI model may be a rule-based decision algorithm that utilizes at least one of a recurrent neural network (RNN), a deep RNN (DRNN), a Q-learning network (QN), a deep Q-learning network (DQN), etc. The RNN may include long short-term memory (LSTM), etc. In some example implementations, the AI model is a large multimodal language model that works with different types of input data, such as text, images, audio, video, etc. The field situation information extracted in step S303 indicates that the user is searching for information about downtime of cell-A. The schema information extracted in step S305 indicates that the data is stored in the “cell_a” table in the “assembly” database, and that the “cell a” table can be accessed by a dashboard an API.

At step S311, the information search code generated is executed to retrieve information required by the user from the various data sources. Through use of the AI model, the execution code generation unit 109 can generate the information retrieval code of “OPEN web browser: dip.com/api/v2.0/dashboard/query?query-up&start-2023-07-10T07:00:00.000Z&place=cell_a”; which can be executed to access raw data such as “psql-d assembly-c “SELECT * FROM cell_a WHERE execute_date>‘2023-07-10T07:00:00.000Z’”. Finally, at step S312, the history table creation unit 106 updates the query history table 107 with the input query, the time of query input, the second query of step S306 or S309, and the information search code associated as past query.

The foregoing example implementation may have various benefits and advantages. For example, by inclusion of current information through use of the field situation table 104 and the schema table 105, search results that track changes in a user's (employee working for a company/assembly plant) situation in real-time can be returned to the user. Users may obtain desired information through input of a simple query. Even queries with the same textual input may return responses that differ from one another based on the user's situation.

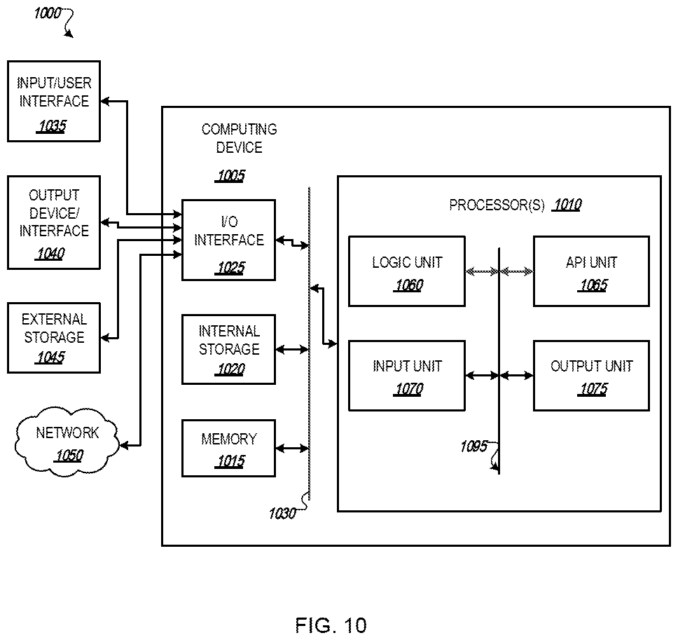

FIG. 10 illustrates an example computing environment with an example computer device suitable for use in some example implementations. Computer device 1005 in computing environment 1000 can include one or more processing units, cores, or processors 1010, memory 1015 (e.g., RAM, ROM, and/or the like), internal storage 1020 (e.g., magnetic, optical, solid-state storage, and/or organic), and/or IO interface 1025, any of which can be coupled on a communication mechanism or bus 1030 for communicating information or embedded in the computer device 1005. IO interface 1025 is also configured to receive images from cameras or provide images to projectors or displays, depending on the desired implementation.

Computer device 1005 can be communicatively coupled to input/user interface 1035 and output device/interface 1040. Either one or both of the input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005.

Examples of computer device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via IO interface 1025) to external storage 1045 and network 1050 for communicating with any number of networked components, devices, and systems, including one or more computer devices of the same or different configuration. Computer device 1005 or any connected computer device can be functioning as, providing services of, or referred to as a server, client, thin server, general machine, special-purpose machine, or another label.

IO interface 1025 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computer device 1005 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided. Processor(s) 1010 can be in the form of hardware processors such as central processing units (CPUs) or in a combination of hardware and software units.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, the input unit 1070, the output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide an output based on the calculations described in example implementations.

Processor(s) 1010 can be configured to receive a first query issued by a user as shown in FIG. 2. The processor(s) 1010 may also be configured to extract a plurality of field status items associated with the first query as shown in FIG. 2. The processor(s) 1010 may also be configured to extract first schema information associated with the plurality of field status items as shown in as shown in FIG. 2. The processor(s) 1010 may also be configured to add the plurality of field status items and the first schema information as contextual information to the first query to generate a second query as shown in FIG. 2. By including current information (field status items and first schema information) as contextual information, this ensures that search results that track changes in a user's (employee working for a company/assembly plant) situation in real-time can be returned to the user. The processor(s) 1010 may also be configured to generate an information search code based on the second query as shown in FIG. 2. The processor(s) 1010 may also be configured to execute the information search code to retrieve information associated with the first query from a plurality of data source systems as shown in FIG. 2. Users are able to obtain desired information through input of a simple query. Even queries with the same textual input may return responses that differ from one another based on the user's situation (e.g. from extracted field status items).

The processor(s) 1010 may also be configured to determine to refer to past queries as shown in FIG. 2. The processor(s) 1010 may also be configured to perform query extraction to extract at least one past query that is similar to the second query as shown in FIG. 2. The processor(s) 1010 may also be configured to identify past query information associated with the at least one past query as shown in FIG. 2. The processor(s) 1010 may also be configured to add the past query information to the second query as shown in FIG. 2. The processor(s) 1010 may also be configured to store the first query, the second query, and the information search code as past query as shown in FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing.” “calculating.” “determining.” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A search query generation method for information retrieval, the method comprising:
receiving, by a processor, a first query issued by a user;
extracting, by the processor, a plurality of field status items associated with the first query using a trained artificial intelligence (TAI) model, wherein the plurality of field status items is extracted from real-time field status information comprising at least one of employee information, order information, work order information, or manufacturing execution information;
extracting, by the processor, first schema information associated with the plurality of field status items using the TAI model, wherein the first schema information comprises at least one of data structure information of data tables, files, or application program interfaces that access data stored across the plurality of data source systems;
adding, by the processor, the plurality of field status items and the first schema information as contextual information to the first query to generate a second query, wherein the contextual information enhances a specificity of the query to improve the information retrieval;
generating, by the processor, an information search code based on the second query using the TAI model; and
executing, by the processor, the information search code to retrieve information associated with the first query from a plurality of data source systems.

2. (canceled)

3. The method of claim 1,
wherein the employee information, the order information, the work order information, and the manufacturing execution information are associated with a company; and
wherein the user is an employee of the company and employee information of the user is extracted from the real-time field status information as part of the plurality of field status items.

4. The method of claim 1,
wherein the first schema information is extracted from second schema information, and the second schema information is related to the data stored across the plurality of data source systems.

5. The method of claim 4, wherein the second schema information comprises schema information of data table associated with the data, schema information of data files associated with the data, and schema information of application program interfaces that access the data.

6. The method of claim 1, further comprising:
determining, by the processor, to refer to past queries;
performing, by the processor, query extraction to extract at least one past query that is similar to the second query;
identifying, by the processor, past query information associated with the at least one past query; and
adding, by the processor, the past query information to the second query.

7. The method of claim 6, further comprising:
storing, by the processor, the first query, the second query, and the information search code as past query.

8. The method of claim 1, wherein the plurality of data source systems comprises enterprise resource planning (ERP) systems, product lifecycle management (PLM) systems, and manufacturing execution systems (MES).

9. The method of claim 1, wherein extraction of the plurality of field status items and extraction of the first schema information are performed in real-time.

10. The method of claim 1, wherein extraction of the plurality of field status items, extraction of the first schema information, and generation of the information search code are performed using trained artificial intelligence models.

11. A search query generation system for information retrieval, the system comprising:
a plurality of data source systems; and
a processor in communication with the plurality of data source systems, wherein the processor is configured to:
receive a first query issued by a user;
extract a plurality of field status items associated with the first query using a trained artificial intelligence (TAI) model, wherein the plurality of field status items is extracted from real-time field status information, including at least one of employee information, order information, work order information, and manufacturing execution information;
extract first schema information associated with the plurality of field status items using the TAI model, wherein the first schema information comprises at least data structure information of data tables, files, and application program interfaces that access data stored across the plurality of data source systems;
add the plurality of field status items and the first schema information as contextual information to the first query to generate a second query, wherein the contextual information enhances the specificity of the query to improve the information retrieval;
generate an information search code based on the second query using the TAI model; and
execute the information search code to retrieve information associated with the first query from the plurality of data source systems.

12. (canceled)

13. The system of claim 1,
wherein the employee information, the order information, the work order information, and the manufacturing execution information are associated with a company; and
wherein the user is an employee of the company and employee information of the user is extracted from the real-time field status information as part of the plurality of field status items.

14. The system of claim 11,
wherein the first schema information is extracted from second schema information, and the second schema information is related to the data stored across the plurality of data source systems.

15. The system of claim 14, wherein the second schema information comprises schema information of data table associated with the data, schema information of data files associated with the data, and schema information of application program interfaces that access the data.

16. The system of claim 11, wherein the processor is further configured to:
determine to refer to past queries;
perform query extraction to extract at least one past query that is similar to the second query;
identify past query information associated with the at least one past query; and
add the past query information to the second query.

17. The system of claim 16, wherein the processor is further configured to:
store the first query, the second query, and the information search code as past query.

18. The system of claim 11, wherein the plurality of data source systems comprises enterprise resource planning (ERP) systems, product lifecycle management (PLM) systems, and manufacturing execution systems (MES).

19. The system of claim 11, wherein extraction of the plurality of field status items and extraction of the first schema information are performed in real-time.

20. The system of claim 11, wherein extraction of the plurality of field status items, extraction of the first schema information, and generation of the information search code are performed using trained artificial intelligence models.
